(19) United States
(12) Patent Application Publication
(10) Pub. No.: US 2015/0078865 A1
(43) Pub. Date: Mar. 19, 2015

(54) POSITIONING APPARATUS AND POSITIONING METHOD FOR OBJECTS

(71) Applicants: HON HAI PRECISION INDUSTRY CO.,LTD., New Taipei (TW); HONG FU JIN PRECISION INDUSTRY (ShenZhen) CO., LTD ., Shenzhen (CN)

(72) Inventor: GUANG-JIAN WANG, Shenzhen (CN)

(73) Assignees: HON HAI PRECISION INDUSTRY CO.,LTD., New Taipei (TW); HONG FU JIN PRECISION INDUSTRY (ShenZhen) CO., LTD, Shenzhen (CN)

(21) Appl. No.: 14/055,890

(22) Filed: Oct. 17, 2013

(30) Foreign Application Priority Data
Sep. 18, 2013 (CN) 2013104244759

(51) Int. Cl. B65G 47/00

(52) U.S. Cl. CPC B65G 47/00
USPC 414/225.01; 414/806

(57) ABSTRACT

A positioning apparatus to position an object defining a receiving space includes a bracket, a positioning block, a positioning sensor, a number of positioning suction nozzles, a row of light transmitters, a row of light sensors, and a controller electrically coupled to the positioning sensor and the light sensors. The bracket includes a supporting plate. The positioning block is mounted on the supporting plate. The positioning sensor and positioning suction nozzles are installed to the positioning block. The light transmitters and the light sensors are mounted on two opposite sides of the supporting plate. The object is supported on the supporting plate, and the positioning block is received in the receiving space of the object. The controller controls the positioning suction nozzles to suck the object. The row of light transmitters and the row of light sensors are used for testing whether the object is positioned or not.

### BACKGROUND

1. Technical Field

The present disclosure relates to a positioning apparatus for objects.

2. Description of Related Art

Electronic devices, such as mobile phones, include a shell. In assembling each mobile phone, the shell is manually positioned to a predetermined position of a supporting bracket, which is inconvenient and the positioning may be inaccurate.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric, exploded view of an embodiment of a positioning apparatus and an object.

FIG. 2 is a side plan view of the positioning apparatus of FIG. 1 and a feeding apparatus, but shows the positioning apparatus in use.

FIG. 3 is a block diagram of the positioning apparatus of FIG. 2.

FIG. 4 is a flow chart of an embodiment of a positioning method of the present disclosure.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

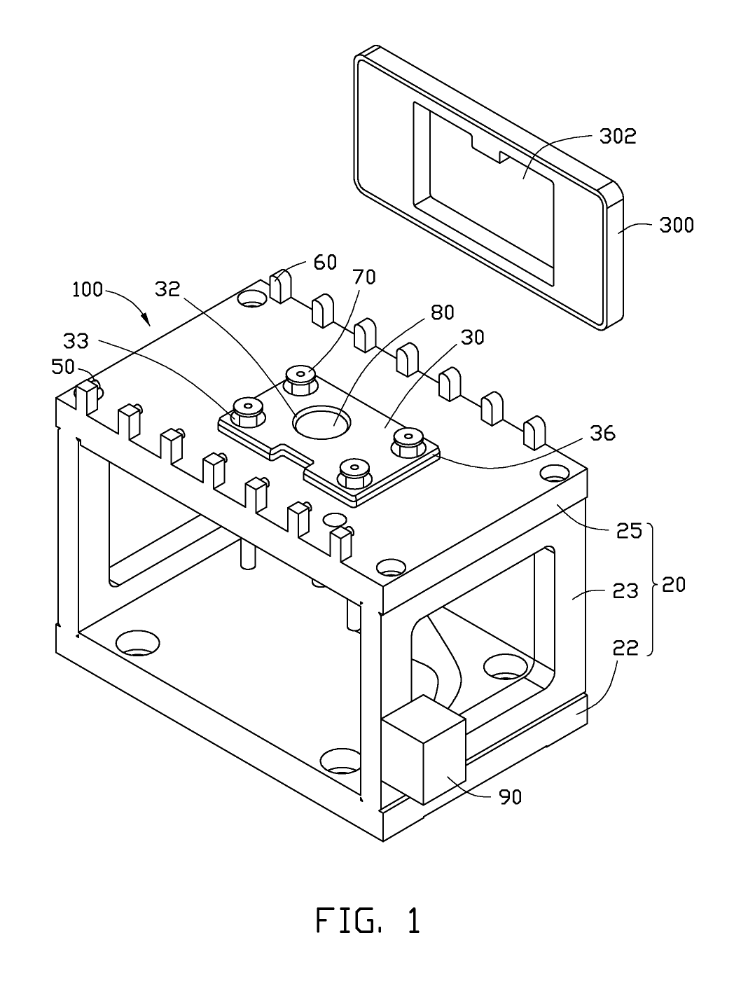

FIG. 1 shows an exemplary embodiment of a positioning apparatus 100. The positioning apparatus 100 is used to position an object 300. The positioning apparatus 100 includes a bracket 20, a positioning block 30, a row of light transmitters 50, a row of light sensors 60, four positioning suction nozzles 70, a positioning sensor 80, and a controller 90 electrically coupled to the positioning sensor 80 and the light sensors 60. In the embodiment, the object 300 is a mobile phone shell, and a bottom of the object 300 defines a receiving space 302.

The bracket 20 includes a substantially rectangular bottom plate 22, two end plates 23 perpendicularly extending up from two opposite ends of the bottom plate 22, and a horizontal supporting plate 25 supported on tops of the end plates 23. The positioning block 30 is similar with the receiving space 302 of the object 300 in shape. The positioning block 30 is detachably mounted on a middle of the supporting plate 25. A middle of the positioning block 30 defines a through hole 32 extending through the supporting plate 25. The positioning block 30 defines four installing holes 33 surrounding the through hole 32. The positioning block 30 defines a slanting guiding surface 36 around four sides of a top of the positioning block 30. The row of light transmitters 50 is mounted on a first side of the supporting plate 25, and the light sensors 60 are mounted on a second side of the supporting plate 25 opposite to the row of light transmitter 50. The number of the light transmitter 50 is equal to the number of the light sensors 60, and the light transmitters 50 are opposite to the light sensors 60 one-to-one. The positioning block 30 is located between the light transmitters 50 and the light sensors 60. The positioning sensor 80 is installed in the through hole 32 of the positioning block 30. The positioning suction nozzles 70 are installed in the installing holes 33 of the positioning block 30.

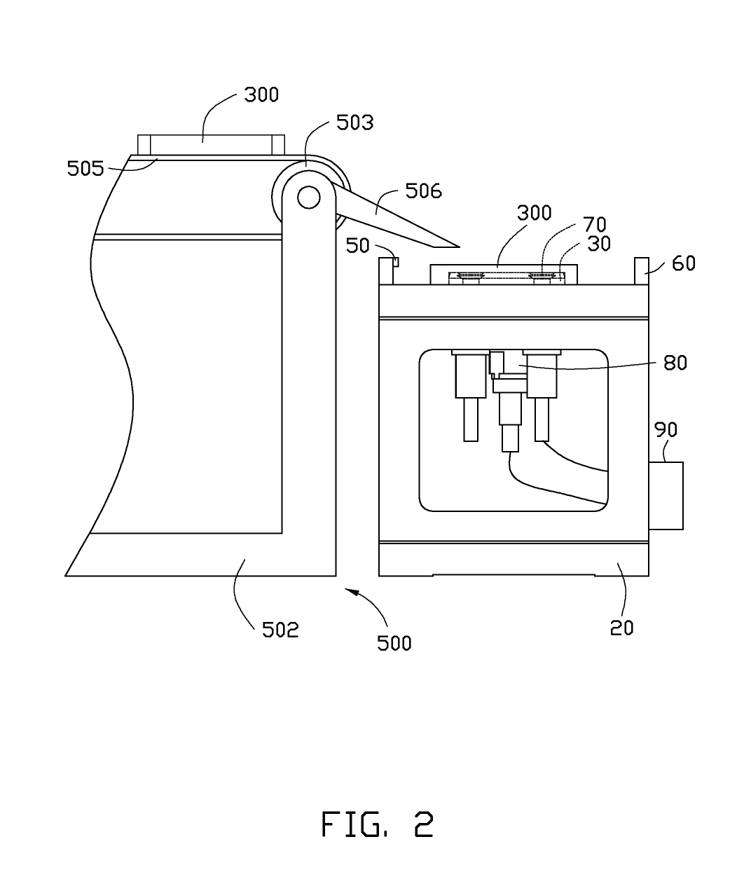

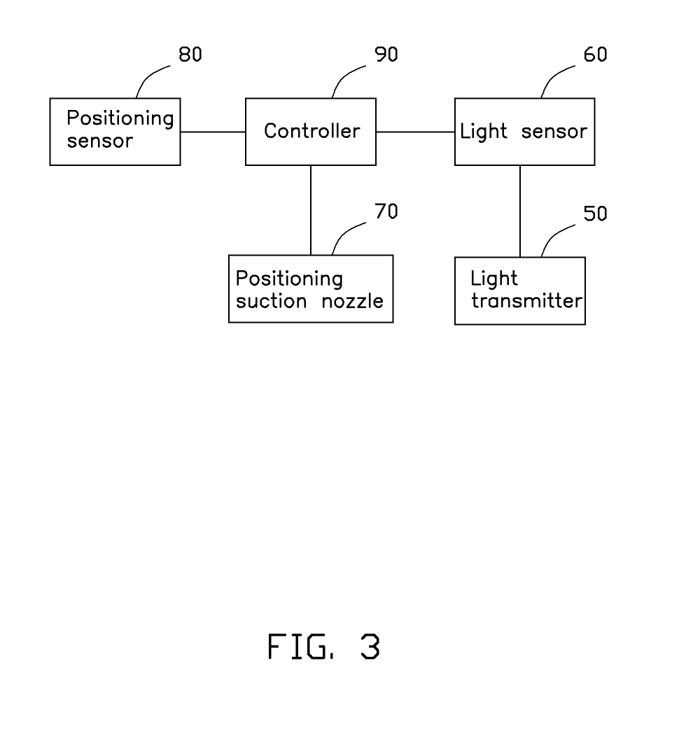

FIGS. 2 and 3 show the positioning apparatus 100 in use, a feeding apparatus 500 is located at a side of the positioning apparatus 100. The feeding apparatus 500 includes a supporting bracket 502, two opposite wheels 503 rotatably installed on the supporting bracket 502, a transport belt 505 slidably fitted about the wheels 503, and a discharge member 506 installed to the supporting bracket 502 and adjacent to the positioning block 30. A plurality of objects 300 is supported on the transport belt 505 in turn. The wheels 503 rotate to slide the transport belt 505. One of the objects 300 slides to the supporting plate 25 through the discharge member 506. The positioning block 30 is received in the receiving space 302 of the object 300 along the guiding surface 36, and the wheels 503 stops rotating. The positioning sensor 80 outputs a signal to the controller 90, to allow the controller 90 to control the positioning suction nozzles 70 to suck the object 300. The light transmitters 50 and the light sensors 60 are used for testing whether the object 300 is positioned or not. The light transmitters 50 emit light. If the light sensors 60 can receive the light, it means the object 300 is properly positioned. If any one of the light sensors 60 cannot receive the light, it means at least one of the positioning suction nozzles 70 does not stick to the object 300, so the object 300 is not positioned horizontally. The light sensors 60 output a signal to the controller 90, the controller 90 controls the positioning suction nozzles 70 to disengage the object 300, until all the light sensors 60 can receive the light.

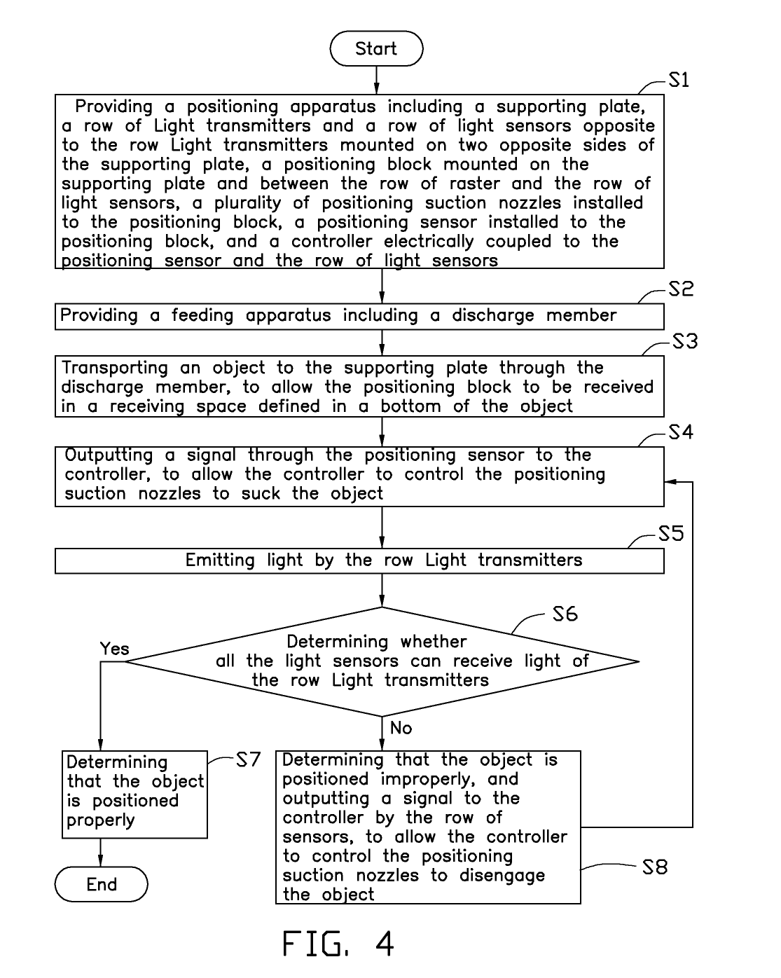

FIG. 4 illustrates a positioning method of the present disclosure. The positioning method includes steps shown below.

In step S1, a positioning apparatus 100 is provided, wherein the positioning apparatus 100 includes a supporting plate 25. A row of light transmitters 50 and a row of light sensors 60 mounted on two opposite sides of the supporting plate 25, a positioning block 30 mounted on the supporting plate 25 between the light transmitters 50 and the light sensors 60. A plurality of positioning suction nozzles 70 installed on the positioning block 30, a positioning sensor 80 installed to the positioning block 30, and a controller 90 electrically coupled to the positioning sensor 80 and the light sensors 60.

In step S2, a feeding apparatus 500 is provided for feeding an object 30 to be positioned to the positioning apparatus 100. Wherein the feeding apparatus 500 is located adjacent to the positioning apparatus 100, and includes a discharge member 506 aligning with the positioning block 30, and a transport belt 505.

In step S3, the transport belt 505 transports the object 300 to the supporting plate 25 through the discharge member 506, to allow the positioning block 30 to be received in a receiving space 302 defined in a bottom of the object 300.

In step S4, the positioning sensor 80 outputs a signal to the controller, to allow the controller 90 to control the positioning suction nozzles 70 to suck the object 300.

In step S5, the light transmitters 50 emit light.

In step S6, a determination is made whether all the light sensors 60 can receive the light of the light transmitters 50. If all the light sensors 60 can receive the light, step S7 is implemented. If any one of the light sensors 60 cannot receive the light, step S8 is implemented.

In step S7, the object 300 is determined to be positioned properly.

In step S8, the object 300 is determined to be positioned improperly, and the light sensors 60 output a signal to the controller 90, to allow the controller 90 to control the positioning suction nozzles 70 to disengage the object 300 and, the process returns to the step S4.

It is to be understood, that even though numerous characteristics and advantages of the embodiment have been set forth in the foregoing description, together with details of the structure and function of the embodiment, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A positioning apparatus for an object defining a receiving space in a bottom, the positioning apparatus comprising:
a bracket comprising a horizontal supporting plate;
a row of light transmitters mounted on a first side of the supporting plate;
a row of light sensors mounted on a second side of the supporting plate opposite to the row of light transmitters;
a positioning block mounted on the supporting plate and between the row of light transmitters and the row of light sensors;
a positioning sensor installed to the positioning block;
a plurality of positioning suction nozzles installed to the positioning block; and
a controller electrically coupled to the positioning sensor and the plurality of light sensors;
wherein the object is supported on the supporting plate, the positioning block is received in the receiving space of the object, the controller controls the plurality of positioning suction nozzles to suck the object, the row of light transmitters emits light, the object is determined to be positioned properly in response to all the light sensors receiving light from the row of light transmitters, the object is determined to be positioned improperly in response to any one of the light sensors not receiving light from the row of light transmitters.

2. The positioning apparatus of claim 1, wherein a number of the row of light transmitters is equal to a number of the row of light sensors, and the row of light transmitters is opposite to the row of light sensors one-to-one.

3. The positioning apparatus of claim 1, wherein the row of light sensors output a signal to the controller in response to there being at least one of the row of light sensors not receiving light from the row of light transmitters, the controller controls the plurality of positioning suction nozzles to disengage the object.

4. The positioning apparatus of claim 1, wherein the positioning block is similar with the receiving space of the object in shape.

5. The positioning apparatus of claim 1, wherein the positioning block defines a through hole extending through the supporting plate, the positioning sensor is installed in the through hole.

6. The positioning apparatus of claim 1, wherein the positioning block defines a plurality of installing holes surrounding the through hole, the plurality of positioning suction nozzles is installed in the plurality of installing holes.

7. The positioning apparatus of claim 1, wherein the positioning block defines a slanting guiding surface around four sides of a top of the positioning block.

8. A positioning method for positioning an object defining a receiving space, the positioning method comprising:
providing a positioning apparatus comprising a supporting plate, a row of light transmitters and a row of light sensors opposite to the row light transmitters mounted on two opposite sides of the supporting plate, a positioning block mounted on the supporting plate and between the row of light transmitters and the row of light sensors, a plurality of positioning suction nozzles installed to the positioning block, a positioning sensor installed to the positioning block, and a controller electrically coupled to the positioning sensor and the row of light sensors;
providing a feeding apparatus for transporting the object to the positioning block;
outputting a signal by the positioning sensor to the controller in response to the object locating on the positioning block, to allow the controller to control the plurality of positioning suction nozzles to suck the object;
emitting light by the light transmitters;
determining whether all the light sensors can receive light of the light transmitters;
determining that the object is positioned properly in response to all the light sensors receiving the light; and
determining that the object is positioned improperly in response to any one of the light sensors not receiving the light, and outputting a signal to the controller by the row of sensors, to allow the controller to control the plurality of positioning suction nozzles to disengage the object.

9. The positioning method of claim 8, wherein the positioning block defines a guiding surface for guiding the object.
